(19) United States
(12) Patent Application Publication
(10) Pub. No.: US 2025/0246828 A1
(43) Pub. Date: Jul. 31, 2025

(54) HIGH PERFORMANCE INTERPOSER AND CHIP SOCKET

(71) Applicant: Amphenol Corporation, Wallingford, CT (US)

(72) Inventors: Paul R. Taylor, Mechanicsburg, PA (US); Vrujesh Patel, Mechanicsburg, PA (US); Justin Shane McClellan, Camp Hill, PA (US); Trent K. Do, Lititz, PA (US); Jim Hileman, Carlisle, PA (US); Stephen B. Smith, Mechanicsburg, PA (US)

(73) Assignee: Amphenol Corporation, Wallingford, CT (US)

(21) Appl. No.: 19/038,993

(22) Filed: Jan. 28, 2025

Related U.S. Application Data
(60) Provisional application No. 63/689,464, filed on Aug. 30, 2024.
(60) Provisional application No. 63/627,403, filed on Jan. 31, 2024.

(51) Int. Cl. H01R 12/71; H01R 13/05

(52) U.S. Cl. CPC H01R 12/714; H01R 13/05

(57) ABSTRACT

An interposer configured for creating multiple connections between electrical components is described. Contacts of the interposer are configured to produce a nonlinear force when compressed. A high spring rate is achieved from zero force to an acceptable force for establishing sufficient electrical connection between the electrical components; and then a lower spring rate is achieved for the remainder of the deflection to minimize the maximum force at the maximum designed compression. The contact includes a curved beam, a tail, and a landing strip. It may also include a solder ball connected to the tail. When the contact is compressed, the curved beam traces an arc in one direction, while the part of the contact touching the landing strip slides along the landing strip in the other direction, thereby reducing the force produced by the contact.

### RELATED APPLICATIONS

This application claims the benefit under 35 U.S.C. § 119 (e) to U.S. Provisional Application No. 63/627,403, filed on Jan. 31, 2024, entitled “HIGH PERFORMANCE INTERPOSER AND CHIP SOCKET”, and U.S. Provisional Application No. 63/689,464, filed on Aug. 30, 2024, entitled “HIGH PERFORMANCE INTERPOSER AND CHIP SOCKET”, each of which is hereby incorporated herein by reference in its entirety.

### FIELD

This patent application relates generally to interconnection systems and more particularly to systems with interposers that provide multiple electrical connections between components.

### BACKGROUND

Electronic systems are frequently assembled by integrating components that each perform specific functions, such as processors, memories, transceivers or other communications interfaces. Such an approach enables different component manufacturers to specialize in the design and manufacture of their components, leading to better performing components. Further, using the same components in multiple electronic systems enables mass production of each component, which provides economies of scale.

Interconnections between components in an electronic system are often provided by a printed circuit board (PCB), which contains multiple layers of conductive structures, including signal traces that can pass electrical signals from one location on the printed circuit board to another. Connections may be made to the conductive structures inside the PCB using holes, drilled fully or partially through the board and then plated with metal. These plated holes, sometimes called vias, are electrically connected to conductive structures within the board through which the holes pass. Connection points on the components, sometimes called leads, might also be connected to the vias, completing a connection between the component and the traces or other conductive structures in the PCB. Connection between leads of the component and the vias might be made, for example, by inserting the lead into the via or by forming a pad on the surface of the PCB on top of the via and connecting the lead to the pad.

Connections between the lead on the component and the via may be made in various ways, such as by using solder or by generating a spring force on the via or a pad attached to the via. In some systems, a component may be attached to a PCB through a socket. The socket has contacts that are connected at a mounting portion to the vias on the PCB and mating portions at the other end that are connected to leads on a component. In some instances, the lead on the component may be a pad on a surface of the component and the mating portions of the contacts of the socket may be compliant so that they exert a force against the pads when the component is pressed into the socket. The socket may include latching structures to hold the component in the socket and press it against the mating portions of the contacts.

A socket may include an interposer, which is a component that can make multiple connections between a printed circuit board and a component pressed against the interposer. Interposers may be made with molded plastic housings and metal contacts inserted in channels in the housing. Interposers may be attached to the printed circuit board in any of multiple ways. For example, solder balls may be attached to the mounting portions of the contacts and the interposer may be attached to the PCB in a reflow solder operation. In other interposers, the mounting portions of the contacts may be spring fingers designed to press against pads on a surface of the PCB. Screws or other hold down structures may ensure that the interposer is pressed against the PCB so that the spring fingers are compressed and generate a desired contact force.

The recent trend in the industry for interconnection systems is to increase the density of the connections made by interposers between components and to increase the overall number of connections, as these allow for greater bandwidth of the electrical signal. This poses a challenge in that satisfying mechanical requirements and, simultaneously, SI requirements becomes increasingly more difficult.

### BRIEF SUMMARY

Some embodiments relate to an interposer configured to place a first component in electrical communication with a second component, the interposer comprising a housing; and a contact, disposed at least partially in the housing, comprising a curved beam, a tail and a landing strip, wherein the curved beam comprises: a first contact portion; and a second contact portion configured to contact the landing strip in response to compression of the curved beam by the first component at the first contact portion, wherein the tail is configured to provide a rigid connection to the second component.

In some embodiments, the contact is shaped so that, in response to compression of the curved beam by the first component, the first contact portion and the second contact portion slide in opposite directions.

In some embodiments, the housing comprises a first surface and a second surface opposite the first surface, wherein the curved beam is near the first surface and the rigid connection is near the second surface, wherein a majority of the curved beam is exposed outside of the housing.

In some embodiments, an entirety of the curved beam is exposed outside of the housing.

In some embodiments, the housing is arranged to allow for clearance of movement for the curved beam in response to compression of the curved beam by the first component.

In some embodiments, an end of the tail is configured to connect to a solder ball.

In some embodiments, the first contact portion forms part of a land grid array (LGA) interface with the first component and the tail forms part of a ball grid array (BGA) interface with the second component.

In some embodiments, the curved beam further comprises a first bent portion forming at least part of the first contact portion; a second bent portion forming at least part of the second contact portion; and a straight portion directly coupling the first and second bent portions to one another.

In some embodiments, when the curved beam is uncompressed, the straight portion defines an angle relative to the landing strip that is between 60° and 80°.

In some embodiments, the contact further comprises a body portion coupled to the tail, the curved beam and the landing strip, wherein the body portion defines a U-shape.

In some embodiments, the contact further comprises a retaining feature configured to place the contact in a fixed positional relationship relative to the housing.

In some embodiments, when the second contact portion is in contact with the landing strip, the contact is configured to reduce maximum impedance variation by at least five ohms in signals transmitted between the first electrical component and the second electrical component, when the second contact portion is in contact with the landing strip, compared to when the second contact portion is not in contact with the landing strip.

In some embodiments, when the second contact portion is in contact with the landing strip, the contact is configured to reduce maximum insertion loss of signals transmitted between the first electrical component and the second electrical component by at least 20 dB in a frequency range of 0-50 GHz, compared to when the second contact portion is not in contact with the landing strip.

In some embodiments, when the second contact portion is in contact with the landing strip, the contact is configured to reduce maximum return loss of signals transmitted between the first electrical component and the second electrical component by at least 30 dB in a frequency range of 0-50 GHz, compared to when the second contact portion is not in contact with the landing strip.

In some embodiments, when the second contact portion is in contact with the landing strip, the contact is configured to reduce losses from mode conversion in signals transmitted between the first electrical component and the second electrical component in a frequency range of 0-70 GHz, compared to when the second contact portion is not in contact with the landing strip.

In some embodiments, a spring rate of a straight portion between the first and second contact portions is configured to decrease in response to compression of the curved beam.

In some embodiments, a spring rate of a body portion between the first contact portion and the tail is configured to decrease in response to compression of the curved beam.

Some embodiments relate to an interposer configured to place a first component in electrical communication with a second component, the interposer comprising: a contact, disposed at least partially in a housing, comprising a curved beam, a tail and a landing strip, wherein the curved beam comprises: a first contact portion; and a second contact portion configured to contact the landing strip in response to compression of the curved beam by the first component at the first contact portion, wherein the contact is shaped so that, in response to compression of the curved beam by the first component, the first contact portion and the second contact portion slide in opposite directions; and wherein the housing is arranged to allow for clearance of movement for the curved beam in response to compression of the curved beam by the first component.

In some embodiments, the housing comprises a first surface and a second surface opposite the first surface, wherein the curved beam is near the first surface and the ball is near the second surface, wherein a majority of the curved beam is exposed outside of the housing.

In some embodiments, an entirety of the curved beam is exposed outside of the housing.

In some embodiments, an end of the tail is configured to connect to a solder ball.

In some embodiments, the first contact portion forms part of a land grid array (LGA) interface with the first component and the tail forms part of a ball grid array (BGA) interface with the second component.

In some embodiments, the curved beam further comprises a first bent portion forming at least part of the first contact portion; a second bent portion forming at least part of the second contact portion; and a straight portion directly coupling the first and second bent portions to one another.

In some embodiments, when the curved beam is uncompressed, the straight portion defines an angle relative to the landing strip that is between 60° and 80°.

In some embodiments, the contact further comprises a body portion coupled to the tail, the curved beam and the landing strip, wherein the body portion defines a U-shape.

In some embodiments, the contact further comprises a retaining feature configured to place the contact in a fixed positional relationship relative to the housing.

In some embodiments, when the second contact portion is in contact with the landing strip, the contact is configured to reduce maximum impedance variation by at least five ohms in signals transmitted between the first electrical component and the second electrical component, when the second contact portion is in contact with the landing strip, compared to when the second contact portion is not in contact with the landing strip.

In some embodiments, when the second contact portion is in contact with the landing strip, the contact is configured to reduce maximum insertion loss of signals transmitted between the first electrical component and the second electrical component by at least 20 dB in a frequency range of 0-50 GHz, compared to when the second contact portion is not in contact with the landing strip.

In some embodiments, when the second contact portion is in contact with the landing strip, the contact is configured to reduce maximum return loss of signals transmitted between the first electrical component and the second electrical component by at least 30 dB in a frequency range of 0-50 GHz, compared to when the second contact portion is not in contact with the landing strip.

In some embodiments, when the second contact portion is in contact with the landing strip, the contact is configured to reduce losses from mode conversion in signals transmitted between the first electrical component and the second electrical component in a frequency range of 0-70 GHz, compared to when the second contact portion is not in contact with the landing strip.

In some embodiments, a spring rate of a straight portion between the first and second contact portions is configured to decrease in response to compression of the curved beam.

In some embodiments, a spring rate of a body portion between the first contact portion and the tail is configured to decrease in response to compression of the curved beam.

Some embodiments relate to a method for placing a first component in electrical communication with a second component using an interposer, wherein the interposer comprises a contact, the method comprising: generating a first spring rate by compressing the contact between the first component and the second component by a first amount; and after the contact has been compressed by the first amount, generating a second spring rate by further compressing the contact between the first component and the second component by a second amount, wherein the second spring rate is less than the first spring rate.

In some embodiments, the contact comprises a first contact portion and a second contact portion, and wherein the contact is shaped so that, in response to compression of the contact by the first component, the first contact portion and the second contact portion slide in opposite directions.

In some embodiments, the first amount ranges up to 0.145 mm and the second amount ranges up to 0.255 mm.

In some embodiments, the first spring rate ranges from 69 g/mm to 77 g/mm and the second spring rate ranges from 40.7 g/mm to 43 g/mm.

Some embodiments relate to an interposer configured to place a first component in electrical communication with a second component, the interposer comprising: a housing; and a contact, disposed at least partially in the housing, wherein the contact is arranged to: generate a first spring rate in response to compression of the contact between the first component and the second component by a first amount; and after being compressed by the first amount, generate a second spring rate in response to further compression of the contact between the first component and the second component by a second amount, wherein the second spring rate is less than the first spring rate.

In some embodiments, the contact comprises a curved beam, a tail and a landing strip, wherein the curved beam comprises a first contact portion; and a second contact portion configured to contact the landing strip in response to compression of the curved beam by the first component at the first contact portion, wherein the tail is configured to provide a rigid connection to the second component.

In some embodiments, the curved beam is shaped so that, in response to compression of the contact by the first component, the first contact portion and the second contact portion slide in opposite directions.

In some embodiments, the housing comprises a first surface and a second surface opposite the first surface, wherein the curved beam is near the first surface and the rigid connection is near the second surface, wherein a majority of the curved beam is exposed outside of the housing.

In some embodiments, an entirety of the curved beam is exposed outside of the housing.

In some embodiments, the housing is arranged to allow for clearance of movement for the curved beam in response to compression of the curved beam by the first component.

In some embodiments, an end of the tail is configured to connect to a solder ball.

In some embodiments, the first contact portion forms part of a land grid array (LGA) interface with the first component and the tail forms part of a ball grid array (BGA) interface with the second component.

In some embodiments, the curved beam further comprises a first bent portion forming at least part of the first contact portion; a second bent portion forming at least part of the second contact portion; and a straight portion directly coupling the first and second bent portions to one another.

In some embodiments, when the curved beam is uncompressed, the straight portion defines an angle relative to the landing strip that is between 60° and 80°.

In some embodiments, the contact further comprises a body portion coupled to the tail, the curved beam and the landing strip, wherein the body portion defines a U-shape.

In some embodiments, a spring rate of a straight portion between the first and second contact portions is configured to decrease in response to compression of the curved beam.

In some embodiments, a spring rate of a body portion between the first contact portion and the tail is configured to decrease in response to compression of the curved beam.

In some embodiments, the contact further comprises a retaining feature configured to place the contact in a fixed positional relationship relative to the housing.

In some embodiments, the first amount ranges up to 0.145 mm and the second amount ranges up to 0.255 mm.

In some embodiments, the first spring rate ranges from 69 g/mm to 77 g/mm and the second spring rate ranges from 40.7 g/mm to 43 g/mm.

Some embodiments relate to an interposer configured to place a first component in electrical communication with a second component, the interposer comprising: an array of contacts, each of the contacts of the array being disposed at least partially in a housing and comprising a landing strip and a curved beam comprising: a first contact portion; and a second contact portion configured to contact the landing strip in response to compression of the curved beam by the first component at the first contact portion, wherein each contact is shaped so that, in response to compression of the curved beam by the first component, the first contact portion and the second contact portion slide in opposite directions; and wherein the housing of each contact is arranged to allow for clearance of movement for the curved beam in response to compression of the curved beam by the first component.

In some embodiments, the housing of each contact comprises a first surface and a second surface opposite the first surface, wherein the curved beam is near the first surface and the ball is near the second surface, wherein a majority of the curved beam is exposed outside of the housing.

In some embodiments, an entirety of the curved beam of each contact is exposed outside of the housing of the contact.

In some embodiments, an end of the tail of each contact is configured to connect to a solder ball.

In some embodiments, the first contact portion of each contact forms part of a land grid array (LGA) interface with the first component and the tail of each contact forms part of a ball grid array (BGA) interface with the second component.

In some embodiments, the curved beam of each contact further comprises a first bent portion forming at least part of the first contact portion; a second bent portion forming at least part of the second contact portion; and a straight portion directly coupling the first and second bent portions to one another.

In some embodiments, when the curved beam of each contact is uncompressed, the straight portion defines an angle relative to the landing strip that is between 60° and 80°.

In some embodiments, each contact further comprises a body portion coupled to the tail, the curved beam and the landing strip, wherein the body portion defines a U-shape.

In some embodiments, each contact further comprises a retaining feature configured to place the contact in a fixed positional relationship relative to the housing.

In some embodiments, a spring rate of a straight portion between the first and second contact portions of the contacts of the array of contacts is configured to decrease in response to compression of the curved beam.

In some embodiments, a spring rate of a body portion between the first contact portion and the tail of the contacts of the array of contacts is configured to decrease in response to compression of the curved beam.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is plot illustrating the force exerted by a contact within an interposer at various amounts of compression of the contact, according to some embodiments.

FIG. 2 is an isometric view of an exemplary contact within an interposer that provides the force-compression characteristics illustrated in FIG. 1.

FIG. 3 is a side view of the exemplary contact of FIG. 2.

FIGS. 4A-4E are side views of the exemplary contact of FIG. 2 depicted at various levels of compression.

FIG. 5 is another side view of the exemplary contact of FIG. 2, including a portion of the housing in which the contact is disposed, shown partially cut away.

FIG. 6A is an exemplary interposer including contacts of the type shown in FIG. 2, arranged in a two-dimensional array with rows and columns, according to some embodiments.

FIG. 6B is a perspective view of an exemplary interposer including contacts of the type shown in FIG. 2, according to some embodiments.

FIG. 7 is a perspective view of an exemplary electronic assembly including the interposer of FIGS. 6A-B, according to some embodiments.

FIG. 8A is a graph of differential impedance measured at the package side of electrical connection systems, according to some embodiments.

FIG. 8B is a graph of differential insertion loss measured at the package side of electrical connection systems, according to some embodiments.

FIG. 8C is a graph of differential return loss measured at the package side of electrical connection systems, according to some embodiments.

FIG. 9A is a graph of differential impedance measured at the PCB side of electrical connection systems, according to some embodiments.

FIG. 9B is a graph of differential insertion loss measured at the PCB side of electrical connection systems, according to some embodiments.

FIG. 9C is a graph of differential return loss measured at the PCB side of electrical connection systems, according to some embodiments.

FIG. 10A is a graph of differential to common return loss measured at the package side of electrical connection systems, according to some embodiments.

FIG. 10B is a graph of differential to common insertion loss measured at the package side of electrical connection systems, according to some embodiments.

FIG. 11A is a graph of differential to common return loss measured at the PCB side of electrical connection systems, according to some embodiments.

FIG. 11B is a graph of differential to common insertion loss measured at the PCB side of electrical connection systems, according to some embodiments.

FIG. 12A is a graph of common to differential return loss measured at the package side of electrical connection systems, according to some embodiments.

FIG. 12B is a graph of common to differential insertion loss measured at the package side of electrical connection systems, according to some embodiments.

FIG. 13A is a graph of common to differential return loss measured at the PCB side of electrical connection systems, according to some embodiments.

FIG. 13B is a graph of common to differential insertion loss measured at the PCB side of electrical connection systems, according to some embodiments.

### DETAILED DESCRIPTION

The inventors have recognized and appreciated techniques for making an interposer to support electrical connections through the interposer with high signal integrity while simultaneously meeting the mechanical requirements for a high density electronic device. Those interposers may enable high integrity connections between arrays of contact points on a first substrate (e.g., a printed circuit board or PCB) and arrays of contact points on a second substrate (e.g., another PCB or a semiconductor chip). These interposers, for example, may form a portion of a chip socket, connecting a semiconductor chip to a PCB of the electronic assembly.

The recent trend in the industry for interconnection systems is to increase the density of the connections (per unit of interposer area) made by interposers between components and to increase the overall number of connections, as these allow for greater bandwidth of the electrical signal. The inventors have recognized and appreciated that to ensure reliable connections across the array while increasing the overall number of contacts and/or the density of contacts per unit area it is desirable to increase the working range of the contacts during compression. The working range of a contact may be viewed as the range of acceptable amounts of compression by which the contact may be compressed while still forming a reliable electrical connection. To ensure that all contacts provide a reliable connection despite inevitable variations in the size and shape of the contacts due to fabrication tolerances, it is desirable to increase the working range. In particular, it is desirable for the contact to be able to form a reliable electrical connection under lower amounts of compression.

The inventors have further recognized and appreciated that mechanical requirements for a high density electronic device, alternatively or additionally, would benefit from a reduction of the maximum spring force exerted by the contact when it is under higher amounts of compression. This is desirable because, as the density of the contacts increases, the force exerted against the component by the contacts increases. Too much force can lead to warpage of the component, resulting in disconnection of some of the contacts from the chip. Thus, the inventors propose reducing the maximum force exerted by each contact in order to avoid the application of too much force against the component.

The inventors have also recognized the benefits of ensuring that zero spring force be exerted by the contacts when compression is zero. Non-zero spring force at zero compression would add substantial complexity to the apparatus, as it would require the addition of extra parts, while also lowering the signal integrity of the connection. Therefore, some embodiments relate to contacts that provide substantially zero spring force in the uncompressed state.

The inventors have recognized and appreciated designs for a contact of an interposer that can provide any of these benefits and may simultaneously provide two or more of these benefits and may further carry high speed electrical signals with high signal integrity. The contact may exert a non-linear force as a function of compression. Such a contact may have, relative to conventional interposer contact designs, an increased working range and/or reduced spring force when compressed. Alternatively, or additionally, the contact may provide zero spring force at zero compression. The contact may be shaped to exert a lower and lower marginal spring force, the more it is compressed, at least in a range between a lower threshold and an upper threshold on the amount of compression.

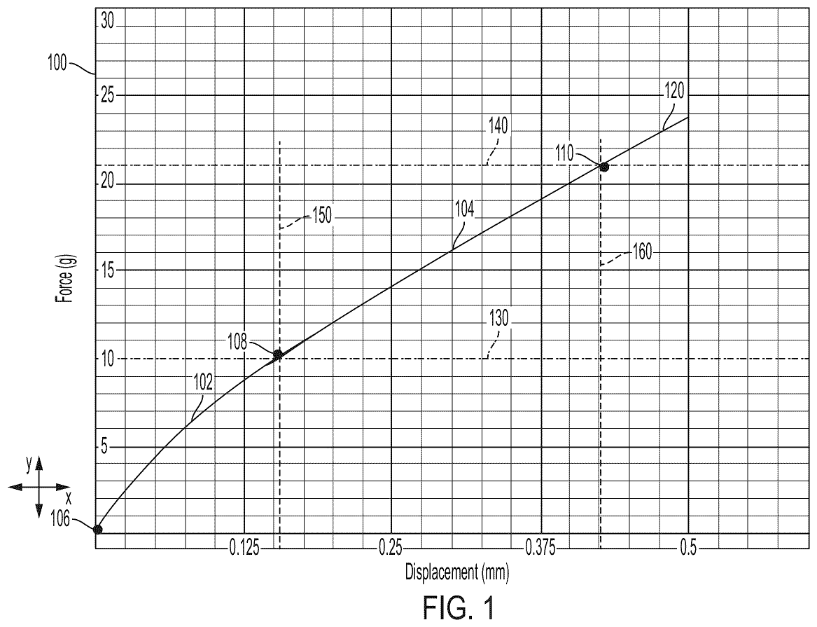

FIG. 1 is a plot (100) illustrating the amount of elastic force generated by a contact as a function of displacement. The displacement is a measure of the compression of the contact in that it represents the extent to which the contact's mating end is displaced along the direction of mating relative to its uncompressed position. Displacement is expressed in millimeters. The force is expressed in grams and represents the amount of elastic force exerted against the component by the contact as it is compressed along the mating direction. Given the compliant nature of the contacts, in general, a larger displacement leads to a larger force. A larger force indicates that the component that compresses the contact must exert more force on the contact to compress it. In other words, if the force provided by that component were released, the spring force exerted by the contacts would force the component away from the contact.

Line 130 represents the threshold force—the smallest amount of force required to ensure sufficiently reliable connections across the contacts of an array. The force should be sufficient to pierce the oxide contaminant layers on the surfaces of the contacts so that there is a reliable metal-to-metal connection. Although the force produced by an array of contacts may exhibit a certain degree of variability due to inevitable fabrication tolerances, it is desirable that the force produced by all the contacts be greater than the threshold force indicated by line 130. The height of line 130 along the vertical axis can be dictated by various considerations, including the type of component to which the contact is designed to connect and the contact density.

Line 140 represents the maximum acceptable amount of elastic force exerted by the contact when it is at the maximum designed compression, which is less than full compression. Beyond the maximum acceptable force, warping of the component and/or warping of the socket may occur, deteriorating the uniformity of compression across the array. In the interest of decreasing warpage notwithstanding an ever increasing density of contacts per unit area, it is desirable to reduce the maximum spring force exerted by the contact when it at the maximum designed compression. Too much force can lead to warpage of the component, resulting in disconnection of some of the contacts from the chip. It should be noted that warping could be prevented in other ways without limiting the maximum designed compression. However, doing so would require an increase in the overall size of the package and/or its weight, thus adding complexity and increasing costs.

In summary, a reliable connection is one in which the contacts of an array, when compressed, exert a spring force that is greater than the threshold force represented by line 130 and less than the maximum acceptable force represented by line 140.

Line 150 and line 160, collectively, represent the working range of the contacts in an array. Line 150 represents the threshold displacement—the smallest amount by which a contact must be displaced to generate a spring force at least equal to the threshold force (see point 108). Line 160 represents the maximum displacement—the largest amount by which a contact may be displaced to generate a spring force that does not exceed the maximum acceptable force (see point 110). To ensure that all contacts provide a reliable connection despite inevitable variations in the size and shape of the contacts due to fabrication tolerances, it is desirable to increase the working range. In particular, it is desirable to increase the working range by decreasing the threshold displacement and/or the maximum displacement.

Curve 120 represents the relationship between force and displacement. Point 106 represents the origin of plot 100. At point 106, a contact exerts zero force in the uncompressed state, which is desirable because biasing the contacts to exert a non-zero force when uncompressed would otherwise require the addition of extra parts. The desire to decrease the threshold displacement and/or to increase the maximum displacement and/or also exerting zero force in the uncompressed state, may be achieved with a curve 120 that exhibits a non-linear behavior, whereby ΔF (the marginal spring force) decreases as the displacement increases. As shown in the example of plot 100, first section 102 of curve 120 passes through point 106 at (0 mm, 0 g) and through point 108 at approximately (0.15 mm, 10 g) on the force-displacement coordinate axes. Second section 104 of curve 120 passes through point 108 and through point 110 at approximately (0.4 mm, 21 g) on the force-displacement coordinate axes. As can be appreciated from the plot, the slope of curve 120 (referred to as the spring rate) decreases as it transitions from section 102 to section 104, resulting in a decrease in the marginal spring force as the displacement increases.

The working range may be at least 0.2 mm, at least 0.21 mm, at least 0.22 mm, at least 0.23 mm, at least 0.24 mm, at least 0.25 mm, at least 0.26 mm, at least 0.27 mm, at least 0.28 mm, at least 0.3 mm, or at least 0.35 mm. In some embodiments, the working range should be less than 0.3 mm or less than 0.35 mm, for example. For example, the working range may be between 0.2 mm and 0.35 mm or between 0.22 mm and 0.3 mm. Given the non-linear nature of the curve, the spring rate in section 102 may larger than the spring rate in section 104. The spring rate within section 102 may be constant and/or the spring rate within section 104 may be constant. When both spring rates are constant, curve 120 is bi-linear. Alternative, either the spring rate within section 102 or the spring rate within section 104 (or both) may vary. In some examples, the maximum spring rate of section 102 ranges from 69 g/mm to 77 g/mm and the maximum spring rate of section 104 ranges from 40.7 g/mm to 43 g/mm.

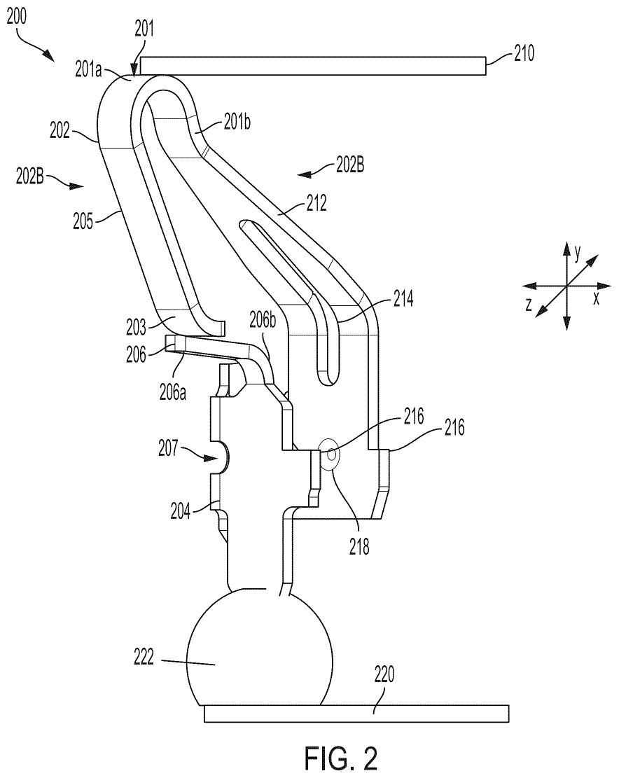

The contacts developed by the inventors and described herein are shaped to provide a force-displacement behavior that resembles curve 120. An example of such a contact is illustrated in FIG. 2. Contact 200 is designed to electrically connect a first electrical component 210 to a second electrical component 220. Electrical components 210 and 220 may represent conductive features (e.g., pads) of a PCB or a semiconductor chip. In one example, electrical component 210 represents a pad on the bottom surface of a processor chip and electrical component 220 represents a pad on the top surface of a PCB.

Contact 200 comprises body portion 212, curved beam 202, tail 204, and landing strip 206. Body portion 212 represents the portion of contact 200 that is held by the housing (not shown in FIG. 2). Body portion 212 is connected to curved beam 202, tail 204, and landing strip 206. Curved beam 202 is shaped to act as a spring, and may include a pair of arms (202a, 202b) connected to each other in a folded arrangement by a bent portion 201. Arm 202a extends between the body portion (212) of the contact to bent portion 201, while arm 202b extends between bent portion 201 and contact portion 203. When it is compressed, curved beam 202 stores potential energy. When it is released, it releases energy by springing back to its uncompressed shape. The spring rate of curved beam 202 may be dictated by the shape and material of the beam. In some embodiments, curved beam defines a cut out portion 214. In this example, cut out portion 214 is defined near the base of curved beam 202, where the curved beam meets the body portion 212. The cut out portion represents a region that is devoid of material. The presence of cut out portion 214 may alter the spring rate of curved beam 202 (relative to the case where the cut out portion is absent). Therefore, in some embodiments, the spring rate of the curved beam may be controlled (among other parameters) by engineering the shape of cut out portion 214.

Compression of curved beam 202 occurs when components 210 and 220 are brought closer to one another. Component 210 may be a PCB and component 220 may be a component in a socket (e.g., a chip). In this case, the components may be brought closer to one another using mechanical components of the socket that press the chip towards the PCB. As a result, component 210 may press against the top portion of curved beam 202. When that occurs, curved beam 202 flexes in the downward direction. In the uncompressed state, curved beam 202 and landing strip 206 are not in direct contact to one another (although they are indirectly connected to one another through body portion 212). As curved beam 202 flexes in response to compression, the lower portion of curved beam 202 is brought closer to landing strip 206. When sufficient force is applied, curved beam 202 lands on landing strip 206, thereby forming an electrical connection. The result is the creation of an electrical path from component 210 to component 220 that passes through the point of contact between curved beam 202 and landing strip 206. As force is increased beyond the point at which curved beam 202 contacts landing strip 206, curved beam 202 maintains a reliable connection by sliding against the top surface of landing strip 206.

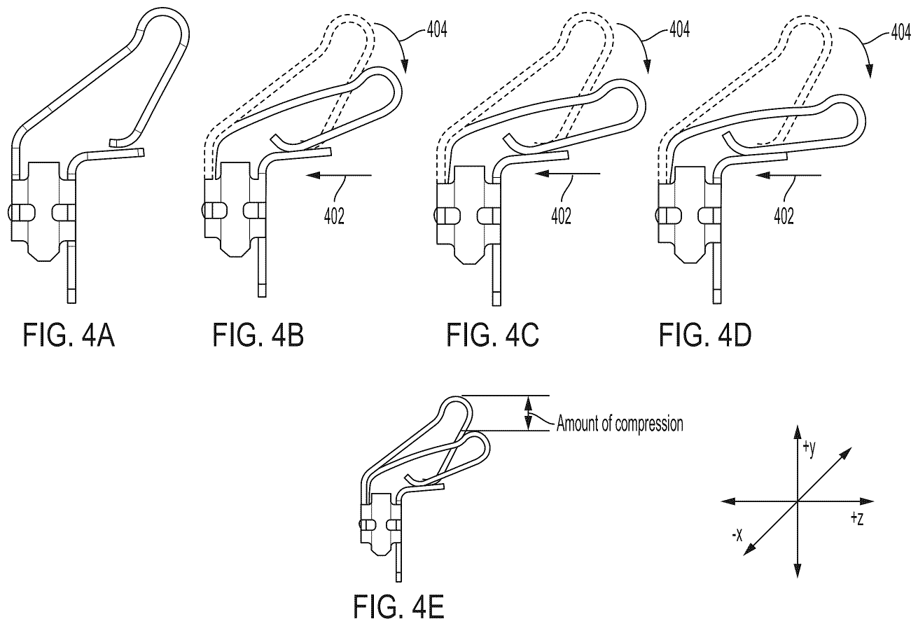

As described in further detail in connection with the mating sequence depicted in FIGS. 4A-4E, the shape of contact 200 may be designed so that, when compressed, contact 200 exerts a spring force that resembles the non-linear behavior illustrated in FIG. 1. When contact 200 is uncompressed, the contact exerts a zero force. When force is applied, the top surface of curved beam 202 (e.g., which may be part of bent portion 201) is displaced along the mating direction (parallel to the y-axis) relative to the uncompressed position. As the displacement of the top portion of curved beam 202 is increased due to further force, the spring force exerted by contact 200 increases, but the marginal change in the spring force decreases. This behavior may be enabled, for example, by allowing different portions of curved beam 202 to move in opposite directions as force is increased. As the force increases, the top portion of curved beam 202 (where the curved portion contacts component 210) moves parallel to the z-axis in the positive direction (in addition to moving along the mating axis). The absence of walls limiting the motion of the top portion of curved beam 202 parallel to the z-axis provides clearance of movement for the top portion of curved beam 202. Simultaneously, as pressure mounts, the lower portion of curved beam 202 (where the curved portion contacts landing strip 206) moves parallel to the z-axis, but in the negative direction. Clearance of motion for the top portion of curved beam 202 in one direction, coupled with the simultaneous motion of the lower portion of curved beam 202 in the opposite direction, may result in the non-linear behavior depicted in FIG. 1.

In further detail, curved beam 202 further comprises first contact portion 201 (where the curved beam contacts component 210) and second contact portion 203 (where the curved beam contacts landing strip 206). First contact portion 201 may comprise a bent portion (e.g., C-shaped portion 201a). C-shaped portion 201a may be positioned so that the concave surface of the “C” faces the negative direction of the y-axis in FIG. 2. The convex surface of the “C” of C-shaped portion 201a may face the opposite direction, pointing in the positive direction of the y-axis and forming the top-most point of contact 200. First contact portion 201 may be connected to the body portion 212 of the contact through another bent portion (e.g., S-shaped portion 201b). S-shaped portion 201b may be connected to C-shaped portion 201a, and, from this connection point, may curve downward along the negative direction of the y-axis before curving backward along the negative direction of the z-axis to attach to the base of curved beam 202.

Straight portion 205 may couple first contact portion 201 and second contact portion 203 together. Straight portion 205 may connect to C-shaped portion 201a at the end opposite to that to which S-shaped portion 201b is connected. In some embodiments, straight portion 205 may define an angle relative to the top surface of landing strip 206—when the contact is uncompressed—that is between 60° and 80°, between 55° and 80°, between 50° and 80°, between 45° and 80°, between 60° and 75°, between 55° and 75°, between 50° and 75°, between 45° and 75°, between 60° and 70°, between 55° and 70°, between 50° and 70°, or between 45° and 70°.

Second contact portion 203 of curved beam 202 may be C-shaped, with one end of the “C” connected to straight portion 205 and the other end curving backward along the negative direction of the z-axis. In response to compression of contact 200 by first electrical component 210, second contact portion 203 contacts landing strip 206 as discussed in detail above. In some embodiments, landing strip 206 may include a cantilevered beam that has straight portion 206a and curved portion 206b. Curved portion 206b may couple straight portion 206a to tail 204.

In the illustrated example, tail 204 is configured to provide a rigid connection to second electrical component 220 (unlike the connection to component 210, which is elastic in nature). Tail 204 may define a cutout 207. Cutout 207 may be C-shaped, such that the “C” opens in the negative direction of the x-axis, as depicted in FIG. 2. Tail 204 may include a retention feature 216 designed to engage with a corresponding feature of a housing (not shown in FIG. 2). Engagement of the retention features with each other promotes a firm connection between the contact and the housing, preventing (or at least limiting) motion of body portion 212 relative to the housing. Thus, body portion 212 is in a fixed positional relationship relative to the housing. In some embodiments, retention feature 216 may include a step that is shaped to engage with a retaining feature formed on an interior wall of the housing. The step may be an indentation at a right angle, such that one vertex of the right angle points horizontally in the positive direction of the x-axis, and the other vertex of the right angle points vertically in the positive direction of the y-axis. Retention feature 216 may be on the opposite side of tail 204 from cutout 207.

In some embodiments, first contact portion 201 forms part of a land grid array (LGA) interface with first electrical component 210, while tail 204 forms part of a ball grid array (BGA) interface with second electrical component 220. The BGA interface between tail 204 and second electrical component 220 allows for increased density of contacts, which ultimately provides greater bandwidth density relative to other type of connections such as quad flat package (QFP). Additionally, BGAs have generally shorter electrical paths, thus leading to better signal integrity. Nonetheless, not all embodiments are limited to tails forming BGA interfaces, as QFP and other types of connections are also possible. In such embodiments, tail 204 may be configured to connect to solder ball 222, through which a BGA interface with second electrical component 220 is formed. Solder ball 222 may be positioned directly below, or in the negative direction of the y-axis relative to, tail 204. At the same time, the LGA interface between contact 200 and first electrical component 210 provides mechanical tolerance.

Body portion 212 may be U-shaped, where the U curves inward along the negative direction of the z-axis. Body portion 212 may also comprise a retention feature 216 designed to engage with a corresponding retention feature on the housing. Additionally, or alternatively, body portion 212 may comprise a different type of retention feature (retention feature 218). Retention feature 218 may be designed to engage with the housing, as well as to assist with biasing contact 200 against the wall of the housing to minimize freedom of rotation and achieve better contact position.

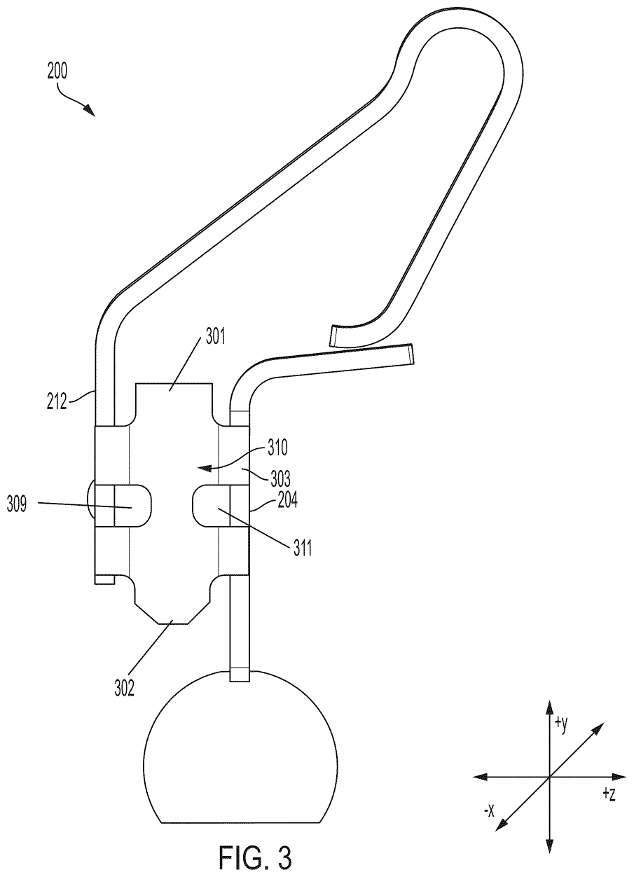

FIG. 3 shows a side view of contact 200. Body portion 212 may have a bridge 310 extending therefrom and connecting it to tail 204. The bridge 310 includes two C-shaped cutouts in either side, including cutout 311 which is connected to cutout 207 and facing the positive Z-direction and cutout 309 facing the negative Z-direction, opposite cutout 311. In some embodiments, bridge 310 may have an appendage at its top that is rectangular in shape, such as appendage 301 shown in FIG. 3. Bridge 310 may also have an appendage at its bottom that is shaped like a half-octagon, such as appendage 302 shown in FIG. 3.

Contact 200 may be shaped such that, upon compression by first electrical component 210 at first contact portion 201, second contact portion 203 slides in one direction against landing strip 206, while first contact portion 201 traces an arc in the opposite direction. FIGS. 4A-4E show a mating sequence at different levels of compression of contact 200. FIG. 4A shows contact 200 in its fully uncompressed state. FIG. 4B shows contact 200 once it has been compressed by an amount of 0.125 mm. The amount of compression is expressed in terms of the displacement of the top-most point of the contact along the y-axis relative to the uncompressed state (as illustrated in FIG. 4E). FIG. 4C shows contact 200 once it has been compressed by an amount of 0.25 mm. FIG. 4D shows contact 200 once it has been compressed by an amount of 0.375 mm. FIG. 4E shows contact 200 once it has been compressed by an amount of 0.4 mm.

As shown in the mating sequence of FIGS. 4A-4E, as the force applied against contact 200 is increased, second contact portion 203 may slide against the landing strip in the negative direction of the z-axis, as indicated by arrow 402. Simultaneously, first contact portion 201 may trace an arc that starts toward the positive direction of the y-axis and then bends towards the positive direction of the z-axis, as indicated by arrow 404. Since first contact portion 201 moves toward the positive direction of the z-axis, and second contact portion 203 moves toward the negative direction of the z-axis, the two contact portions move in opposite directions when contact 200 is compressed. This opposed motion effectively reduces the marginal rate of change of the spring force (the spring rate) exerted by contact 200. This effect may be viewed as the result of the fact that as arm 202a deflects, the force produced by arm 202a increases linearly, but the extent to which arm 202b deflects varies depending on the amount of compression, thus leading to a reduction in the force produced by arm 202b. This reduction of the spring rate with increased compression results in the non-linear spring force described in connection with FIG. 1.

Further, the design of the contact 200 provides additional mechanical benefits. For example, when deflected, straight portion 205 stores elastic energy to maintain force between the second contact portion 203 and the landing strip 206, ensuring an electrical connection is made at that location and allowing for shunting of electrical current within the contact. The benefits of shunting within contacts are further discussed below. In addition, straight portion 205 prevents the compression forces within the contact from exceeding a maximum threshold because the spring rate of straight portion 205 decreases through deflection. The spring rate of straight portion 205 decreases through deflection because the Z distance between 212 and 201 increases through deflection, causing the straight portion 205 to have a reduced contribution to the total normal force within the contact.

In addition, body portion 212 stores enough elastic energy to maintain a connection between the first contact portion 201 and the first electrical component 210. Body portion 212 additionally contributes to the reduced compressive forces within the contact because the spring rate of the body portion 212 decreases through deflection. The spring rate of 212 decreases through deflection because the Z distance between 201 and 203 increases during deflection, which reduces the contribution of body portion 212 to the total normal force of the contact.

The design of the contacts allows for an arc to be traced during a mating procedure, such as described with respect to FIGS. 4A-E. This arc, combined with the sliding of the second contact portion along the length of the landing strip as the compression force increases, allows for an increased working range of the contact in making electrical connections. In addition, the contact is configured such that there is zero spring force exerted at zero compression, which simplifies the mating process.

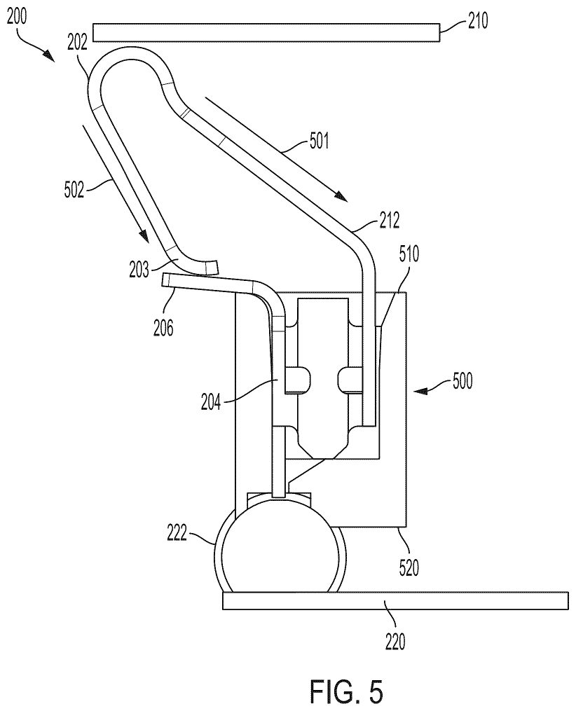

To ensure that first contact portion 201 traces an arc as depicted in FIGS. 4A-4E, it is desirable to provide clearance of motion for curved beam 202. Clearance of motion, in turn, may be ensured by the absence of sidewalls that may otherwise limit the range of motion of curved beam 202 along the z-axis. FIG. 5 is another side view illustrating contact 200 embedded in a portion of housing 500. Housing 500 includes a top surface 510 and a bottom surface 520, which opposes top surface 510. Housing 500 may hold other contacts (not shown in FIG. 5) of the types described herein. Clearance of motion for curved beam 202 along z-axis may be ensured by the absence of vertical walls (parallel to the mating direction) which would otherwise confine the range of motion of the curved beam in a way that would negatively affect the desired force-displacement non-linear behavior. Thus, in some embodiments, the majority (e.g., at least 50%, 60%, 70%, 80% or 90%), or even the entirety, of curved beam 202 extends beyond top surface 510 of housing 500 when contact 200 is uncompressed. As shown in the example of FIG. 5, when contact 200 is uncompressed, the entire portion of contact 200 above landing strip 206 may be exposed beyond top surface 510 of housing 500. Meanwhile, bottom surface 520 of housing 500 may be positioned at the upper portion of solder ball 222, such that tail 204 is entirely within housing 500. The exposure of solder ball 222 below bottom surface 520 allows for electrical connection of contact 200 with second electrical component 220.

The structure of electrical contacts may additionally allow for shunting of electrical current within contacts. A compressible electrical contact, such as 200, may have components which interact and form an electrical connection when the contact is compressed. These electrical connections may allow for shunting of current through the electrical contact, by providing multiple paths for current to flow through. This shunting of current may provide improved performance characteristics of electrical contacts and electrical connections systems, which is described later herein.

The contact 200 in FIG. 5 illustrates such shunting. The contact 200 has compressed during mating with components 210 and 220, such as described with reference to FIGS. 4A-E, such that second contact portion 203 contacts landing strip 206. When second contact portion 203 and landing strip 206 are in contact, electrical current may pass between the contact portion and the landing strip, forming a shunt for the current passing between the electrical components 210 and 220. As a result of the contact between the second contact portion 203 and the landing strip 206, two paths, 501 and 502, for electrical current are created in contact 200. Path 501 flows from the first contact portion 201 through body portion 212 and to tail 204, where it may flow to component 220 via solder ball 222. Path 502 flows from first contact portion 201 through straight portion, through second contact portion 203, through landing strip 206, and to tail 204, where it may flow to component 220 via solder ball 222.

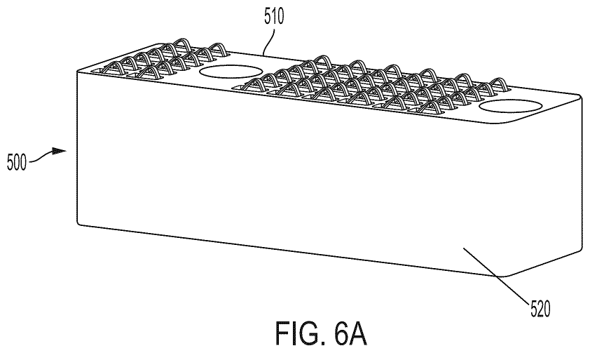

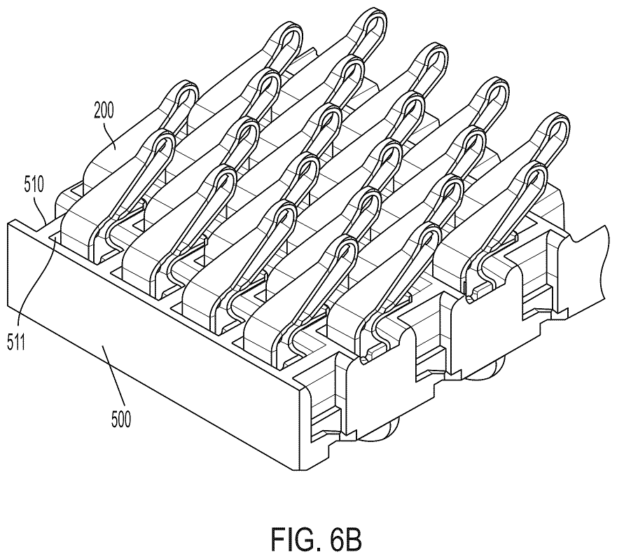

Housing 500 may be configured to hold an array of contacts 200, as shown in the exemplary implementations of FIG. 6A and FIG. 6B. In both examples, an interposer is formed that includes a bi-dimensional array of rows and columns of contacts. Similar to what is shown in FIG. 5, the top portion of each of the contacts in the array may be exposed above the top surface 510 of housing 500. Solder balls (not fully shown in FIGS. 6A-6B), which are attached to the tails of each of the contacts, may be exposed below the bottom surface 520 of housing 500, in order to form a BGA interface with second electrical component 220, as discussed above.

In the example of FIG. 6B, the top surface 510 includes holes 511, which the contacts 200 are exposed through. The top surface 510 is substantially planar such that the contacts 200 may move and be compressed during a mating process to form electrical connections to electrical components, such as 210 of FIG. 2.

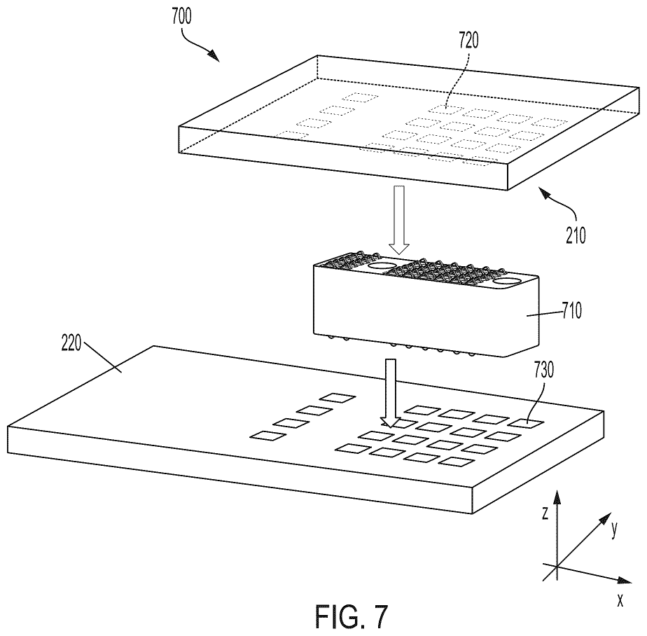

FIG. 7 is a simplified perspective view of an electronic assembly including an interposer, in accordance with some embodiments. A similar configuration may be implemented using the interposer of FIG. 6B. Electronic assembly 700 includes first and second electrical components 210 and 220, and an interposer 710. Interposer 710 may include a housing 500 and an array of contacts 200. First and second electrical components 210 and 220 may be any type of electrical component. For example, second electrical component 220 may be a PCB (e.g., a motherboard) and first electrical component 210 may be a semiconductor card (e.g., a processor card). In such arrangements, interposer 710 may be a portion of a chip socket including mounting hardware attached to second electrical component 220 (not shown for simplicity of illustration). Alternatively, first electrical component 210 may also be a PCB or a connector carrying cables connected to a device positioned outside assembly 700.

In electronic assembly 700, the electrical interface of second electrical component 220 is in a plane parallel to the plane of the electrical interface of first electrical component 210. In the example of FIG. 7, first electrical component 210 includes pads 720 formed on the bottom surface of first electrical component 210, and second electrical component 220 includes pads 730 formed on the top surface of second electrical component 220, where the bottom surface of first electrical component 210 is parallel to the top surface of second electrical component 220. During operation, pads 720 are in electrical contact with pads 730 via interposer 710.

Interposer 710 may be mounted to second electrical component 220 (using posts, bolts, latches, or other hardware not shown for simplicity), and electrical connections may be formed via spring loaded contacts, such as contact 200 illustrated in other figures and described above. Solder balls (not shown in FIG. 7) may establish a BGA interface between interposer 710 and second electrical component 220 through a solder reflow operation, thereby allowing for an electrical connection to be formed between interposer 710 and second electrical component 220. Further, first electrical component 210 may be pressed into the top surface of interposer 710.

Electronic assembly 700 may include posts, bolts, latches, or other hardware (not shown in FIG. 7) to hold first electrical component 210 to the interposer and to press the component against the exposed portions of the interposer contacts. In some embodiments, the exposed upper portions of the contacts of the interposer 710 may be compliant and may exert a force against pads 720 when first electrical component 210 is pressed against the interposer, as discussed above.

As described above, the shunting of electrical current through an electrical contact may provide improved performance in electrical connections, for example those made by interposers between electrical components. For example, a contact with shunting, such as contact 200, may provide more constant impedance, improved insertion loss, lower return loss and reduced noise from mode conversion.

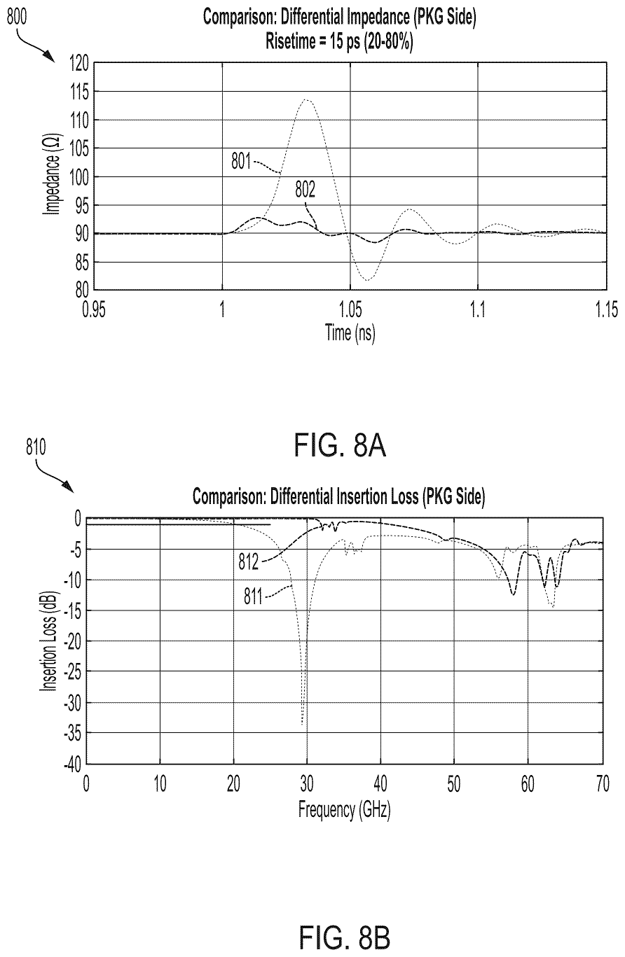

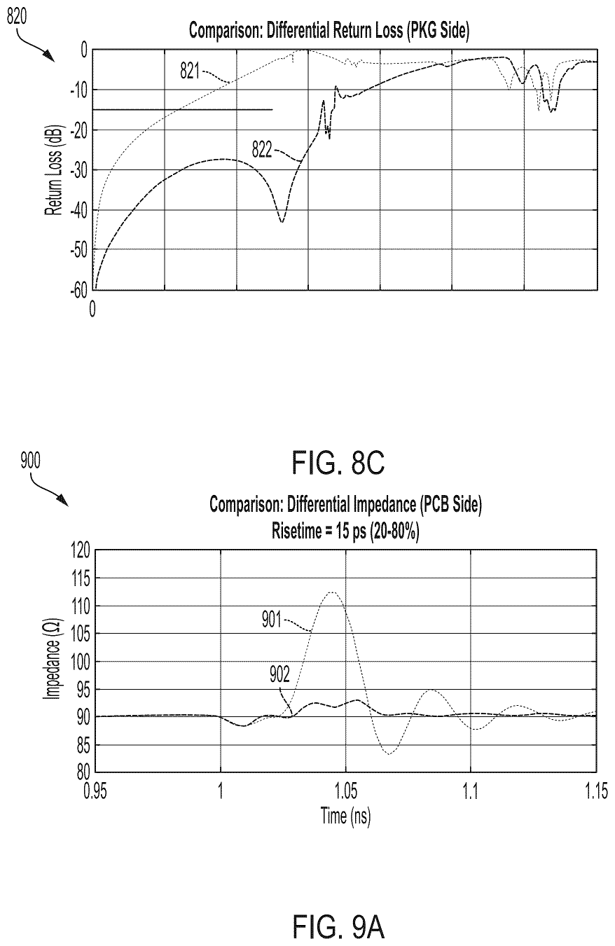

FIGS. 8A-13B are graphs representing different performance metrics of electrical connection systems, such as sockets, including contacts as described herein, for example contacts 200 of FIG. 2. The performance metrics were determined using simulations of electrical connection systems in a frequency range from 0 to 70 GHz. The performance metrics were determined for electrical connection systems with both unshunted and shunted contacts. Unshunted contacts are contacts which have not been sufficiently deflected for the contact portions to contact the landing strips, or contacts which do not have features that enable shunting. This results in a single path for current to flow through contacts, such as path 501 of FIG. 5. Shunted contacts are contacts which have been sufficiently deflected for the contact portions to contact the landing strips, such as described with reference to FIG. 5, where there are two paths for electrical current to flow through the contact.

FIG. 8A is a graph of the differential impedance of an electrical connection system, of a signal launched at the package side electrical connection system. The package side of an electrical connection system may be the side of the system including contact portions of electrical contacts, for example contact portions 201 of electrical contacts 200, as described with reference to FIG. 2. The line 801 represents the impedance of a signal launched at the package side of an electrical connection system with unshunted contacts. The line 802 represents the impedance of a signal launched at the package side of an electrical connection with shunted contacts.

In the graph 800, the y-axis shows the value of the impedance that a signal encounters as it travels through the electrical connection systems. The x-axis represents the time since the signal was transmitted.

The characteristic impedance selected for the electrical connection represented in FIG. 8A was 90 ohms. In such electrical connection systems, it is important for the impedance of all components to be as close as possible to the characteristic impedance. Mismatched impedances can degrade signal quality and prevent signals from passing through the electrical connection system. Impedance mismatches can cause signals to reflect towards the source as opposed to passing through the connection system.

As can be seen in the graph 800, the impedance of the electrical connection system with unshunted contacts, represented by line 801, experiences a sharp increase to about 112 ohms beginning around Ins, approximately when the signal reaches the electrical connection system. The impedance then decreases to approximately 82 ohms and continues to oscillate due to the reflections of the signal occurring because of the impedance mismatch.

The impedance of the electrical system with shunted contacts, represented by line 802, experiences significantly smaller deviations from the characteristic impedance of 90 ohms. The line 802 experiences an increase in impedance to about 93 ohms beginning at about 1 ns, approximately when the signal reaches the electrical connection system. The signal then experiences some oscillations and decreases to a minimum impedance of about 88 ohms at approximately 1.06 ns.

As is clear from the graph 800, the electrical connections system with shunted contacts experiences less impedance variation than with unshunted contacts. This represents an improvement in the performance of the electrical connection system and results in improved signal quality.

FIG. 8B is a graph of the differential insertion loss of a signal launched at the package side of an electrical connection system. Insertion loss is a measure of the portion of a signal which arrives at its intended destination, with ideal insertion loss being as close as possible to 0 dB. Insertion loss across electrical connection systems varies with signal frequency, with the magnitude of insertion loss increasing with frequency.

Graph 810 includes the differential insertion loss for an electrical connection system with unshunted and shunted contacts. Line 811 represents the differential insertion loss for the electrical connection system with unshunted contacts. Line 811 remains close to 0 dB from 0 GHz to about 10 GHz, and then begins to decrease to a minimum of about −35 dB at about 30 GHz, and then varies between −5 dB and −15 dB in the frequency range from about 30−70 GHz.

Line 812 represents the differential insertion loss for the electrical connection system with shunted contacts. Line 912 remains close to 0 dB from 0 GHz to about 32 GHz. The insertion loss represented by line 912 then varies between around −1 dB and −12 dB in the frequency range from about 32-70 GHz.

The electrical connection system with shunted contacts has improved performance compared to when the contacts are unshunted. When the contacts are shunted, the insertion loss remains close to 0 dB across a larger frequency range than the electrical connection system with unshunted contacts. Further, the differential insertion loss remains at a lower magnitude for the electrical connection systems with shunted contacts than the electrical connection system with unshunted contacts. Therefore, shunted contacts provide improved performance for electrical connection systems, as a greater portion of a transmitted signal will reach its intended destination across more frequencies.

FIG. 8C is a graph of the differential return loss of a signal launched at the package side of an electrical connection system. The differential return loss is the ratio representing the amount of a signal that is reflected to the source. Differential return loss under ideal conditions is negative infinity dB, where there is no reflection of the signal, and the differential return loss should be minimized for improved performance.

Graph 820 includes the differential return loss for an electrical connection system with unshunted contacts and an electrical connection system with shunted contacts. Line 821 represents the differential return loss for the electrical connection system with unshunted contacts. Line 821 increases from −60 dB to about −16 dB in the frequency range of 0 GHz to about 10 GHz. Line 821 then increases to about 0 dB at about 30 GHz, and varies between −5 dB and −15 dB in the frequency range between 30 GHz and 70 GHZ.

Line 822 represents the differential return loss for the electrical connection system with shunted contacts. Line 822 increases from −60 dB to about −30 dB in the frequency range of 0 GHz to about 20 GHz. Line 821 decreases to about −43 dB at about 26 GHZ and then increases to about −2 dB at about 58 GHz and varies between −5 dB and −16 dB in the frequency range between 58 GHz and 70 GHz.

The electrical connection system with shunted contacts again has improved performance compared to the electrical connection system with unshunted contacts. When the contacts are shunted, the differential return loss remains significantly lower than that of the connection system with shunted contacts, across a large frequency range. This indicates that a smaller portion of the signal is reflected back to the source and that the electrical connection system has improved performance with contact shunting.

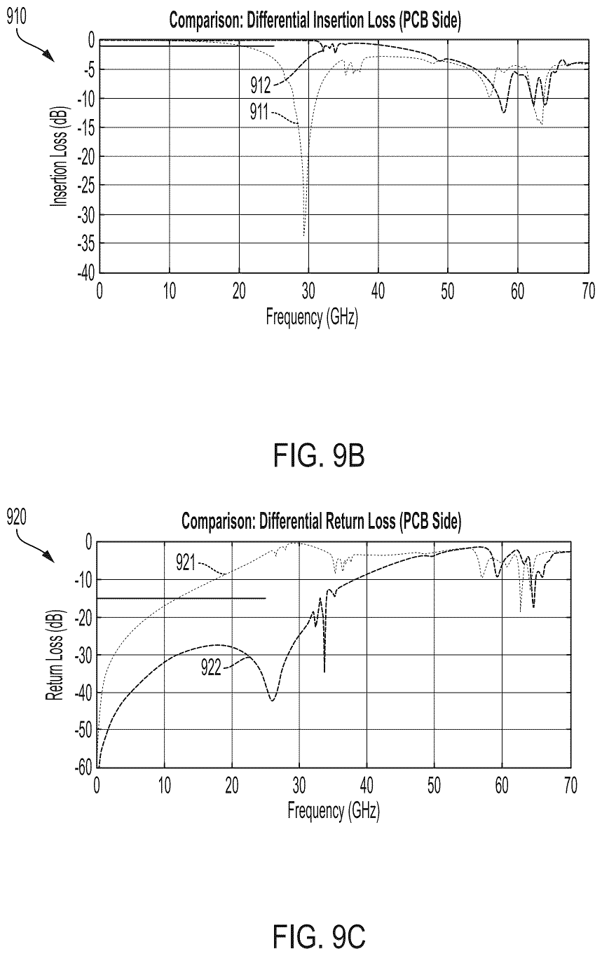

FIGS. 9A-C represent performance characteristics of an electrical connection system with shunted contacts and an electrical connections system with unshunted contacts, from signals launched at the PCB side of the electrical connection systems. The PCB side of an electrical connection system may be the side of the system including tails or solder balls for connections, for example tail 204 or solder balls 222 of electrical contacts 200, as described with reference to FIG. 2.

FIG. 9A is a graph of the differential impedance from a signal launched at the PCB side of an electrical connection system. The line 901 represents the impedance measured from an electrical connection system with unshunted contacts, and the line 902 represents the impedance measured from electrical connection with shunted contacts.

The characteristic impedance selected for the electrical connection system used in collecting the data represented in FIG. 9A was 90 ohms.

As can be seen in the graph 900, the impedance of the electrical connection system with unshunted contacts, represented by line 901, experiences a dip to about 88 ohms followed by a sharp increase to about 112 ohms beginning around Ins, approximately when the signal reaches the electrical connection system. The impedance then decreases to approximately 84 ohms and continues to oscillate due to the reflections of the signal occurring because of the impedance mismatch.

The impedance of the electrical system with shunted contacts, represented by line 902, experiences significantly smaller deviations from the characteristic impedance of 90 ohms. The line 902 experiences a dip to about 88 ohms followed by an increase in impedance to about 93 ohms beginning at about 1 ns, approximately when the signal reaches the electrical connection system. The signal then experiences some oscillations between about 90 ohms and 93 ohms.

As is clear from the graph 900, the electrical connections system with shunted contacts experiences less impedance variation than with unshunted contacts. This represents an improvement in the performance of the electrical connection system and results in improved signal quality. This demonstrates the shunted contacts provide improved signal quality for signals launched at both the package and PCB sides of an electrical connections system.

FIG. 9B is a graph of the differential insertion loss from a signal launched at the PCB side of electrical connection systems.

Graph 910 includes the differential insertion loss for an electrical connection system with unshunted and an electrical connection system with shunted contacts. Line 911 represents the differential insertion loss for the electrical connection system with unshunted contacts. Line 911 remains close to 0 dB from 0 GHz to about 15 GHZ, and then begins to decrease to a minimum of about −35 dB at about 29 GHz, and then varies between −3 dB and −15 dB in the frequency range from about 30-70 GHz.

Line 912 represents the differential insertion loss for the electrical connection system with shunted contacts. Line 12 remains close to 0 dB from 0 GHz to about 32 GHz. The insertion loss represented by line 912 then varies between around −1 dB and −13 dB in the frequency range from about 32-70 GHz.

The electrical connection system with shunted contacts again demonstrates improved performance compared to the unshunted contacts, with signals launched at the PCB side. When the contacts are shunted, the insertion loss remains close to 0 dB across a larger frequency range than the electrical connection system with unshunted contacts. Further, the differential insertion loss remains at a lower magnitude for the electrical connection systems with shunted contacts than the electrical connection system with unshunted contacts. Therefore, shunted contacts provide improved performance for electrical connection systems, as a greater portion of a transmitted signal will reach its intended destination across more frequencies.

FIG. 9C is a graph of the differential return loss of signals launched at the PCB side of electrical connection systems. Graph 920 includes the differential return loss for an electrical connection system with unshunted and an electrical connection system with shunted contacts. Line 921 represents the differential return loss for the electrical connection system with unshunted contacts. Line 921 increases from −60 dB to about −17 dB in the frequency range of 0 GHz to about 10 GHz. Line 921 then increases to about 0 dB at about 29 GHZ, and varies between −5 dB and −18 dB in the frequency range between 29 GHz and 70 GHZ.

Line 922 represents the differential return loss for the electrical connection system with shunted contacts. Line 922 increases from −60 dB to about −28 dB in the frequency range of 0 GHz to about 20 GHz. Line 921 decreases to about −41 dB at about 26 GHz and then increases to about −2 dB at about 57 GHz and varies between −5 dB and −17 dB in the frequency range between 57 GHz and 70 GHz.

The electrical connection system with shunted contacts again has improved performance compared to the electrical connection system with unshunted contacts for signals launched at both the package and PCB sides. At the PCB side, when the contacts are shunted, the differential return loss remains significantly lower than that of the connection system with shunted contacts, across a large frequency range. This indicates that a smaller portion of the signal is reflected back to the source and that the electrical connection system has improved performance with contact shunting.

In some examples, an electrical connection system may operate in a differential mode, where adjacent contacts act as two signal lines, with one carrying a positive voltage signal and the other carrying a negative voltage signal, equal and opposite to the positive voltage signal. When operating in differential mode, common mode noise can be introduced to the signal due to mode conversion. Common mode noise is a signal of equal sign that arises in both the positive and negative voltage signals. Common mode noise is undesirable when operating in differential mode as it degrades signal quality and can cause electromagnetic interference within the electrical connection system.

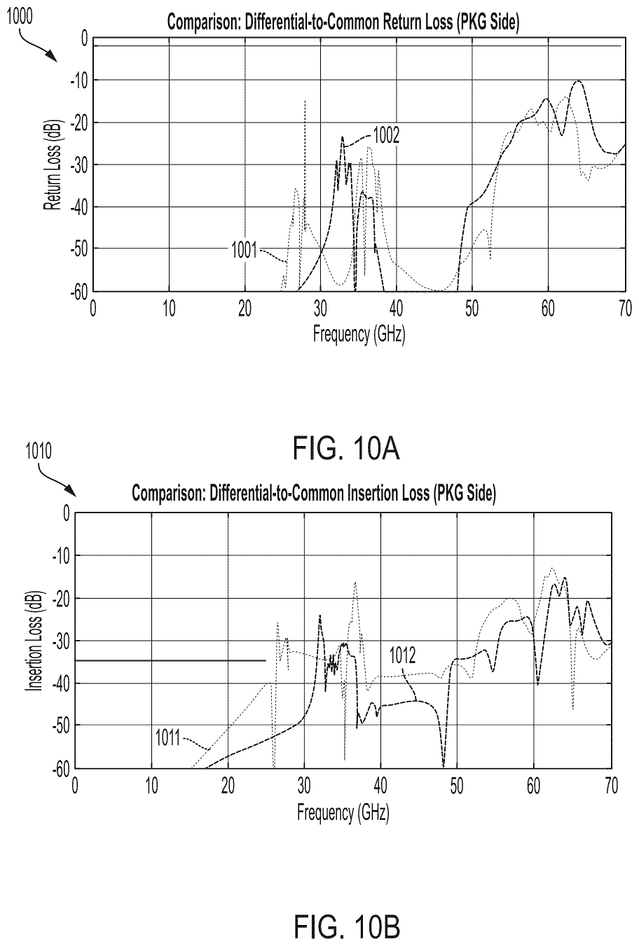

FIG. 10A is a graph of differential to common return loss resulting from common mode noise introduced in differential signals transmitted through electrical connection systems, from signals launched at the package side of the electrical connection systems. The return loss is measured at the signal source side of the electrical connection system. In graph 1000, line 1001 represents the return loss generated by an electrical connection system with unshunted contacts, and line 1002 represents the return loss generated by an electrical connection system with shunted contacts. The return loss generated by the electrical connection system with shunted contacts is lower than that of the unshunted contacts at frequencies below 30 GHz and 35-47 GHz. The return loss for the shunted contacts is slightly higher than that of the unshunted contacts at frequencies between 30 and 35 GHz, and has similar performance to the unshunted contacts between 47 and 70 GHz.

FIG. 10B is a graph of differential to common insertion loss resulting from common mode noise introduced in differential signals transmitted through electrical connection systems, from signals launched at the package side of the electrical connection systems. The insertion loss is measured at the signal receiving side of the electrical connection systems. In graph 1010, line 1011 represents the insertion loss generated by an electrical connection system with unshunted contacts, and line 1012 represents the insertion loss generated by an electrical connection system with shunted contacts. The insertion loss generated by the electrical connection system with shunted contacts is less than that generated by the unshunted contacts across almost all frequencies. The shunted contacts have slightly higher insertion loss than the unshunted contacts at around 32 GHz, between 49 and 52 GHZ, about 59 GHz and between 62 and 70 GHz.

As shown by graphs 1000 and 1010 of FIGS. 10A-B, the electrical connection system with shunted contacts results in lower common mode noise being generated in differential mode signals. This indicates the shunting results in improved signaling in electrical connection systems when operating in differential mode.

Similar performance improvements are seen when measuring the common mode noise generated from differential signals launched at the PCB side.

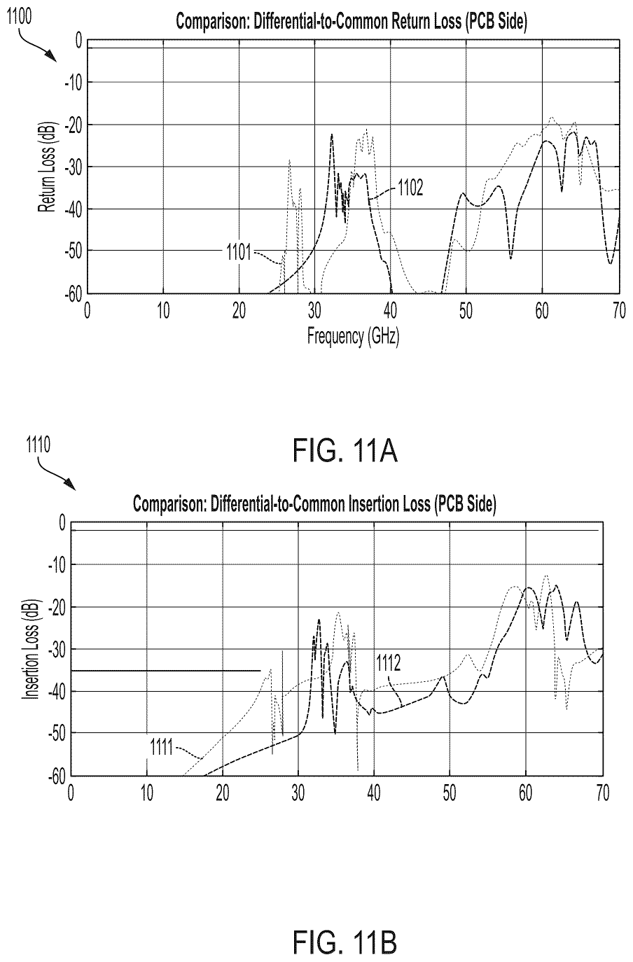

FIG. 11A is a graph of differential to common return loss resulting from common mode noise introduced in differential signals transmitted through electrical connection systems, from signals launched at the PCB side of the electrical connection systems. The return loss is measured at the signal source side of the electrical connection systems. In graph 1100, line 1101 represents the return loss generated by an electrical connection system with unshunted contacts, and line 1102 represents the return loss generated by an electrical connection system with shunted contacts. The return loss generated by the electrical connection system with shunted contacts is lower than that of the unshunted contacts at frequencies below 28 GHZ, frequencies between 35 and 46 GHz and at most frequencies between 52 and 70 GHz. The return loss for the shunted contacts is slightly higher than that of the unshunted contacts at frequencies between 27 and 35 GHZ, and between 46 and 52 GHZ.

FIG. 11B is a graph of differential to common insertion loss resulting from common mode noise introduced in differential signals transmitted through electrical connection systems, from signals launched at the PCB side of the electrical connection systems. The insertion loss is measured at the signal receiving side of the electrical connection systems. In graph 1110, line 1111 represents the insertion loss generated by an electrical connection system with unshunted contacts, and line 1112 represents the insertion loss generated by an electrical connection system with shunted contacts. The insertion loss generated by the electrical connection system with shunted contacts is less than that generated by the unshunted contacts across almost all frequencies. The shunted contacts have slightly higher insertion loss than the unshunted contacts between 32 and 35 GHZ, between 59 and 62 GHz, and between 64 and 68 GHZ.

As described above, with reference to FIGS. 10A-B the decreased return and insertion loss generated by electrical connection systems with shunted contacts compared to unshunted contacts indicates the shunting provides improved performance and signal quality for signals launched at both the package and PCB sides of the electrical connection system when operating in differential mode.

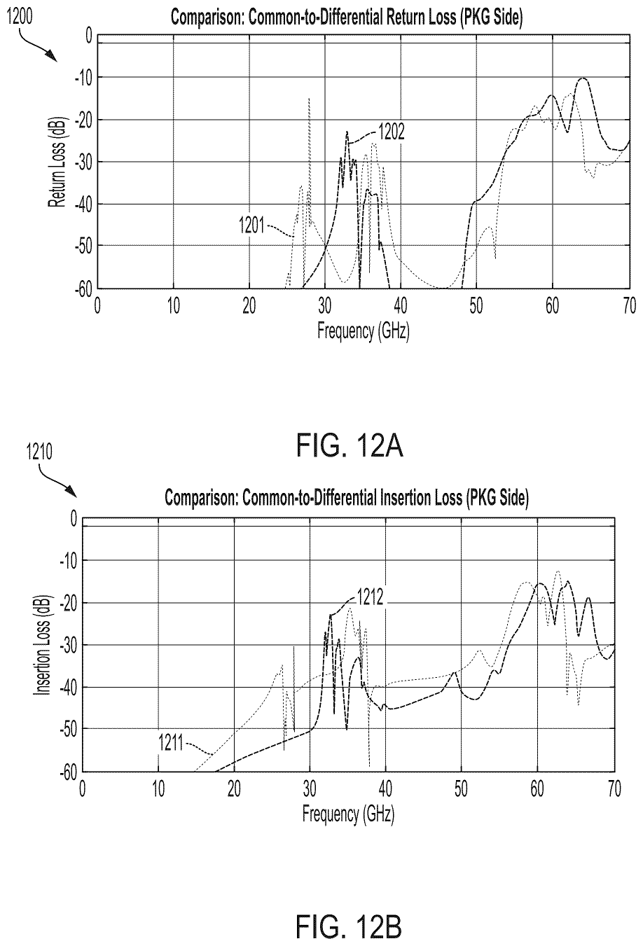

Electrical connection systems with shunting contacts additionally provide improvements in signal quality by reducing common to differential return and insertion losses, resulting from mode conversion. FIG. 12A is a graph of the common to differential return loss, from signals launched at the package side of the electrical connection system. The return loss is measured at the signal source side of the connection system. In graph 1200, line 1201 represents the return loss generated by an electrical connection system with unshunted contacts, and line 1202 represents the return loss generated by an electrical connection system with shunted contacts. Line 1202 remains below 1201 at frequencies below 30 GHz and between 35 and 48 GHz, and has similar values to line 1201 at the remaining frequencies. FIG. 12B is a graph of common to differential insertion loss, fir signals launched at the package side of the electrical connection systems. The insertion loss is measured at the signal receiving side of the electrical connection systems. In graph 1210, line 1211 represents the insertion loss generated by an electrical connection system with unshunted contacts, and line 1212 represents the insertion loss generated by an electrical connection system with shunted contacts. The insertion loss generated by the electrical connection system with shunted contacts is less than that generated by the unshunted contacts across almost all frequencies.

As shown by graphs 1200 and 1210 of FIGS. 12A-B, the electrical connection system with shunted contacts results in lower differential mode noise being generated in common mode signals. This indicates the shunting results in improved signaling in electrical connection systems when operating in common mode.

Similar performance improvements are seen when measuring the differential mode noise generated from differential signaling from signals launched at the PCB side.

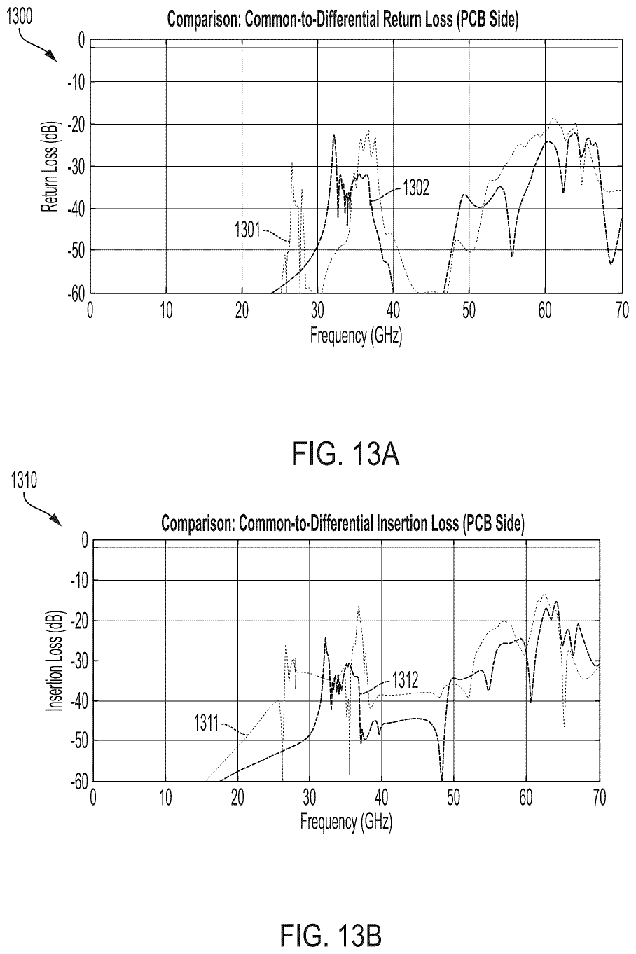

FIG. 13A is a graph of the common to differential return loss in signals transmitted through electrical connection systems, from signals launched at the PCB side of the electrical connection systems. The return loss is measured at the signal source side of the connection system. In graph 1300, line 1301 represents the return loss generated by an electrical connection system with unshunted contacts, and line 1302 represents the return loss generated by an electrical connection system with shunted contacts. Line 1302 remains below 1301 at most frequencies below 30 GHz and between 35 and 47 GHZ, and has similar values to line 1301 at the remaining frequencies. FIG. 13B is a graph of common to differential insertion loss in signals transmitted through electrical connection systems launched at the package side of the electrical connection systems. The insertion loss is measured at the signal receiving side of the electrical connection systems. In graph 1310, line 1311 represents the insertion loss generated by an electrical connection system with unshunted contacts, and line 1312 represents the insertion loss generated by an electrical connection system with shunted contacts. The insertion loss generated by the electrical connection system with shunted contacts is less than that generated by the unshunted contacts across almost all frequencies.

The decreased common to differential return loss and insertion loss generated in electrical connection systems with shunted contacts when compared to unshunted contacts, demonstrates that the shunting provides improved performance and signal quality. As described above, with reference to FIGS. 8A-13B, shunting within contacts of electrical connection systems provides improved performance characteristics compared to electrical connection systems without shunting. These improved performance characteristics include reduced variance in differential impedance, lower magnitude of differential insertion loss, reduced differential return loss, and reduced noise from mode conversion.

Having thus described several embodiments, it is to be appreciated various alterations, modifications, and improvements may readily occur to those skilled in the art. Such alterations, modifications, and improvements are intended to be within the spirit and scope of the invention. For example, compression-based connections may be used in some embodiments in lieu of BGAs at the interface with component 220. Changes in the dimensions of the components described here are also contemplated, as is the number and/or density of contacts, the contact displacement and/or the applied force.

A chip socket has been described as an example of a component containing an interposer. Techniques as described herein may be used to construct an interposer used for any suitable purpose, such as to join two parallel printed circuit boards. Similarly, a printed circuit board was used as an example of a substrate with conductive structures to be connected to another device through an interposer. Techniques as described herein may be used to connect any suitable substrate to another electronic component.

Terms signifying direction, such as “upwards” and “downwards,” were used in connection with some embodiments. These terms were used to signify direction based on the orientation of components illustrated or connection to another component, such as a surface of a printed circuit board to which a termination assembly is mounted. It should be understood that electronic components may be used in any suitable orientation. Accordingly, terms of direction should be understood to be relative, rather than fixed to a coordinate system perceived as unchanging, such as the earth's surface.

Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Also, circuits and modules depicted and described may be reordered in any order, and signals may be provided to enable reordering accordingly.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

All definitions, as defined and used herein, should be understood to control over dictionary definitions, definitions in documents incorporated by reference, and/or ordinary meanings of the defined terms. The indefinite articles “a” and “an,” as used herein in the specification and in the claims, unless clearly indicated to the contrary, should be understood to mean “at least one.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Also, the phraseology and terminology used herein are for the purpose of description and should not be regarded as limiting. The use of “including,” “comprising,” “having,” “containing,” or “involving,” and variations thereof herein, is meant to encompass the items listed thereafter (or equivalents thereof) and/or as additional items.

Various aspects are described in this disclosure, which include, but are not limited to, the following aspects:

1. An interposer configured to place a first component in electrical communication with a second component, the interposer comprising: a housing; and a contact, disposed at least partially in the housing, comprising a curved beam, a tail and a landing strip, wherein the curved beam comprises: a first contact portion; and a second contact portion configured to contact the landing strip in response to compression of the curved beam by the first component at the first contact portion, wherein the tail is configured to provide a rigid connection to the second component.

2. The interposer of aspect 1, wherein the contact is shaped so that, in response to compression of the curved beam by the first component, the first contact portion and the second contact portion slide in opposite directions.

3. The interposer of any of aspects 1-2, wherein the housing comprises a first surface and a second surface opposite the first surface, wherein the curved beam is near the first surface and the rigid connection is near the second surface, wherein a majority of the curved beam is exposed outside of the housing.

4. The interposer of any of aspects 1-3, wherein an entirety of the curved beam is exposed outside of the housing.

5. The interposer of any of aspects 1-4, wherein the housing is arranged to allow for clearance of movement for the curved beam in response to compression of the curved beam by the first component.

6. The interposer of any of aspects 1-5, wherein an end of the tail is configured to connect to a solder ball.

7. The interposer of any of aspects 1-6, wherein the first contact portion forms part of a land grid array (LGA) interface with the first component and the tail forms part of a ball grid array (BGA) interface with the second component.

8. The interposer of any of aspects 1-7, wherein the curved beam further comprises: a first bent portion forming at least part of the first contact portion; a second bent portion forming at least part of the second contact portion; and a straight portion directly coupling the first and second bent portions to one another.

9. The interposer of aspect 8, wherein, when the curved beam is uncompressed, the straight portion defines an angle relative to the landing strip that is between 60° and 80°.

10. The interposer of any of aspects 1-9, wherein the contact further comprises a body portion coupled to the tail, the curved beam and the landing strip, wherein the body portion defines a U-shape.

11. The interposer of any of aspects 1-10, wherein the contact further comprises a retaining feature configured to place the contact in a fixed positional relationship relative to the housing.

12. The interposer of any of aspects 1-11, wherein when the second contact portion is in contact with the landing strip, the contact is configured to reduce maximum impedance variation by at least five ohms in signals transmitted between the first electrical component and the second electrical component, when the second contact portion is in contact with the landing strip, compared to when the second contact portion is not in contact with the landing strip.

13. The interposer of any of aspects 1-12, wherein when the second contact portion is in contact with the landing strip, the contact is configured to reduce maximum insertion loss of signals transmitted between the first electrical component and the second electrical component by at least 20 dB in a frequency range of 0-50 GHz, compared to when the second contact portion is not in contact with the landing strip.

14. The interposer of any of aspects 1-13, wherein when the second contact portion is in contact with the landing strip, the contact is configured to reduce maximum return loss of signals transmitted between the first electrical component and the second electrical component by at least 30 dB in a frequency range of 0-50 GHZ, compared to when the second contact portion is not in contact with the landing strip.

15. The interposer of any of aspects 1-14, wherein when the second contact portion is in contact with the landing strip, the contact is configured to reduce losses from mode conversion in signals transmitted between the first electrical component and the second electrical component in a frequency range of 0-70 GHz, compared to when the second contact portion is not in contact with the landing strip.

16. The interposer of any of aspects 1-15, wherein a spring rate of a straight portion between the first and second contact portions is configured to decrease in response to compression of the curved beam.

17. The interposer of any of aspects 1-16, wherein a spring rate of a body portion between the first contact portion and the tail is configured to decrease in response to compression of the curved beam.

18. An interposer configured to place a first component in electrical communication with a second component, the interposer comprising: a contact, disposed at least partially in a housing, comprising a curved beam, a tail and a landing strip, wherein the curved beam comprises: a first contact portion; and a second contact portion configured to contact the landing strip in response to compression of the curved beam by the first component at the first contact portion, wherein the contact is shaped so that, in response to compression of the curved beam by the first component, the first contact portion and the second contact portion slide in opposite directions; and wherein the housing is arranged to allow for clearance of movement for the curved beam in response to compression of the curved beam by the first component.

19. The interposer of aspect 18, wherein the housing comprises a first surface and a second surface opposite the first surface, wherein the curved beam is near the first surface and the ball is near the second surface, wherein a majority of the curved beam is exposed outside of the housing.

20. The interposer of aspect 19, wherein an entirety of the curved beam is exposed outside of the housing.

21. The interposer of any of aspects 18-20, wherein an end of the tail is configured to connect to a solder ball.

22. The interposer of any of aspects 18-21, wherein the first contact portion forms part of a land grid array (LGA) interface with the first component and the tail forms part of a ball grid array (BGA) interface with the second component.

23. The interposer of any of aspects 18-22, wherein the curved beam further comprises: a first bent portion forming at least part of the first contact portion; a second bent portion forming at least part of the second contact portion; and a straight portion directly coupling the first and second bent portions to one another.

24. The interposer of aspect 23, wherein, when the curved beam is uncompressed, the straight portion defines an angle relative to the landing strip that is between 60° and 80°.

25. The interposer of any of aspects 18-24, wherein the contact further comprises a body portion coupled to the tail, the curved beam and the landing strip, wherein the body portion defines a U-shape.

26. The interposer of any of aspects 18-25, wherein the contact further comprises a retaining feature configured to place the contact in a fixed positional relationship relative to the housing.

27. The interposer of any of aspects 18-26, wherein when the second contact portion is in contact with the landing strip, the contact is configured to reduce maximum impedance variation by at least five ohms in signals transmitted between the first electrical component and the second electrical component, when the second contact portion is in contact with the landing strip, compared to when the second contact portion is not in contact with the landing strip.

28. The interposer of any of aspects 18-27, wherein when the second contact portion is in contact with the landing strip, the contact is configured to reduce maximum insertion loss of signals transmitted between the first electrical component and the second electrical component by at least 20 dB in a frequency range of 0-50 GHz, compared to when the second contact portion is not in contact with the landing strip.

29. The interposer of any of aspects 18-28, wherein when the second contact portion is in contact with the landing strip, the contact is configured to reduce maximum return loss of signals transmitted between the first electrical component and the second electrical component by at least 30 dB in a frequency range of 0-50 GHz, compared to when the second contact portion is not in contact with the landing strip.

30. The interposer of any of aspects 18-29, wherein when the second contact portion is in contact with the landing strip, the contact is configured to reduce losses from mode conversion in signals transmitted between the first electrical component and the second electrical component in a frequency range of 0-70 GHz, compared to when the second contact portion is not in contact with the landing strip.

31. The interposer of any of aspects 18-30, wherein a spring rate of a straight portion between the first and second contact portions is configured to decrease in response to compression of the curved beam.

32. The interposer of any of aspects 18-31, wherein a spring rate of a body portion between the first contact portion and the tail is configured to decrease in response to compression of the curved beam.

33. A method for placing a first component in electrical communication with a second component using an interposer, wherein the interposer comprises a contact, the method comprising: generating a first spring rate by compressing the contact between the first component and the second component by a first amount; and after the contact has been compressed by the first amount, generating a second spring rate by further compressing the contact between the first component and the second component by a second amount, wherein the second spring rate is less than the first spring rate.

34. The method of aspect 33, wherein the contact comprises a first contact portion and a second contact portion, and wherein the contact is shaped so that, in response to compression of the contact by the first component, the first contact portion and the second contact portion slide in opposite directions.

35. The method of any of aspects 33-34, wherein the first amount ranges up to 0.145 mm and the second amount ranges up to 0.255 mm.

36. The method of any of aspects 33-35, wherein the first spring rate ranges from 69 g/mm to 77 g/mm and the second spring rate ranges from 40.7 g/mm to 43 g/mm.

37. An interposer configured to place a first component in electrical communication with a second component, the interposer comprising: a housing; and a contact, disposed at least partially in the housing, wherein the contact is arranged to: generate a first spring rate in response to compression of the contact between the first component and the second component by a first amount; and after being compressed by the first amount, generate a second spring rate in response to further compression of the contact between the first component and the second component by a second amount, wherein the second spring rate is less than the first spring rate.

38. The interposer of aspect 37, wherein the contact comprises a curved beam, a tail and a landing strip, wherein the curved beam comprises: a first contact portion; and a second contact portion configured to contact the landing strip in response to compression of the curved beam by the first component at the first contact portion, wherein the tail is configured to provide a rigid connection to the second component.

39. The interposer of aspect 38, wherein the curved beam is shaped so that, in response to compression of the contact by the first component, the first contact portion and the second contact portion slide in opposite directions.

40. The interposer of any of aspects 38-39, wherein the housing comprises a first surface and a second surface opposite the first surface, wherein the curved beam is near the first surface and the rigid connection is near the second surface, wherein a majority of the curved beam is exposed outside of the housing.

41. The interposer of any of aspects 38-40, wherein an entirety of the curved beam is exposed outside of the housing.

42. The interposer of any of aspects 38-41, wherein the housing is arranged to allow for clearance of movement for the curved beam in response to compression of the curved beam by the first component.

43. The interposer of any of aspects 38-42, wherein an end of the tail is configured to connect to a solder ball.

44. The interposer of any of aspects 38-43, wherein the first contact portion forms part of a land grid array (LGA) interface with the first component and the tail forms part of a ball grid array (BGA) interface with the second component.

45. The interposer of any of aspects 38-44, wherein the curved beam further comprises: a first bent portion forming at least part of the first contact portion; a second bent portion forming at least part of the second contact portion; and a straight portion directly coupling the first and second bent portions to one another.

46. The interposer of aspect 45, wherein, when the curved beam is uncompressed, the straight portion defines an angle relative to the landing strip that is between 60° and 80°.

47. The interposer of any of aspects 38-46, wherein the contact further comprises a body portion coupled to the tail, the curved beam and the landing strip, wherein the body portion defines a U-shape.

48. The interposer of any of aspects 38-47, wherein a spring rate of a straight portion between the first and second contact portions is configured to decrease in response to compression of the curved beam.

49. The interposer of any of aspects 37-48, wherein a spring rate of a body portion between the first contact portion and the tail is configured to decrease in response to compression of the curved beam.

50. The interposer of any of aspects 38-49, wherein the contact further comprises a retaining feature configured to place the contact in a fixed positional relationship relative to the housing.

51. The interposer of any of aspects 37-50, wherein the first amount ranges up to 0.145 mm and the second amount ranges up to 0.255 mm.

52. The interposer of any of aspects 37-51, wherein the first spring rate ranges from 69 g/mm to 77 g/mm and the second spring rate ranges from 40.7 g/mm to 43 g/mm.

53. An interposer configured to place a first component in electrical communication with a second component, the interposer comprising: an array of contacts, each of the contacts of the array being disposed at least partially in a housing and comprising a landing strip and a curved beam comprising: a first contact portion; and a second contact portion configured to contact the landing strip in response to compression of the curved beam by the first component at the first contact portion, wherein each contact is shaped so that, in response to compression of the curved beam by the first component, the first contact portion and the second contact portion slide in opposite directions; and wherein the housing of each contact is arranged to allow for clearance of movement for the curved beam in response to compression of the curved beam by the first component.

54. The interposer of aspect 53, wherein the housing of each contact comprises a first surface and a second surface opposite the first surface, wherein the curved beam is near the first surface and the ball is near the second surface, wherein a majority of the curved beam is exposed outside of the housing.

55. The interposer of aspect 54, wherein an entirety of the curved beam of each contact is exposed outside of the housing of the contact.

56. The interposer of any of aspects 53-55, wherein an end of the tail of each contact is configured to connect to a solder ball.

57. The interposer of any of aspects 53-56, wherein the first contact portion of each contact forms part of a land grid array (LGA) interface with the first component and the tail of each contact forms part of a ball grid array (BGA) interface with the second component.

58. The interposer of any of aspects 53-57, wherein the curved beam of each contact further comprises: a first bent portion forming at least part of the first contact portion; a second bent portion forming at least part of the second contact portion; and a straight portion directly coupling the first and second bent portions to one another.

59. The interposer of aspect 58, wherein, when the curved beam of each contact is uncompressed, the straight portion defines an angle relative to the landing strip that is between 60° and 80°.

60. The interposer of any of aspects 53-59, wherein each contact further comprises a body portion coupled to the tail, the curved beam and the landing strip, wherein the body portion defines a U-shape.

61. The interposer of any of aspects 53-60, wherein each contact further comprises a retaining feature configured to place the contact in a fixed positional relationship relative to the housing.

62. The interposer of any of aspects 53-61, wherein a spring rate of a straight portion between the first and second contact portions of the contacts of the array of contacts is configured to decrease in response to compression of the curved beam.

63. The interposer of any of aspects 53-62, wherein a spring rate of a body portion between the first contact portion and the tail of the contacts of the array of contacts is configured to decrease in response to compression of the curved beam.

What is claimed is:

1. An interposer configured to place a first component in electrical communication with a second component, the interposer comprising:
a housing; and
a contact, disposed at least partially in the housing, comprising a curved beam, a tail and a landing strip, wherein the curved beam comprises:
a first contact portion; and
a second contact portion configured to contact the landing strip in response to compression of the curved beam by the first component at the first contact portion, wherein the tail is configured to provide a rigid connection to the second component.

2. The interposer of claim 1, wherein the contact is shaped so that, in response to compression of the curved beam by the first component, the first contact portion slides along the first component in a direction opposite that which the second contact portion slides along the landing strip.

3. The interposer of claim 1, wherein the housing comprises a first surface and a second surface opposite the first surface, wherein the curved beam is near the first surface and the rigid connection is near the second surface, wherein a majority of the curved beam is exposed outside of the housing.

4. The interposer of claim 3, wherein an entirety of the curved beam is exposed outside of the housing.

5. The interposer of claim 1, wherein the housing is arranged to allow for clearance of movement for the curved beam in response to compression of the curved beam by the first component.

6. The interposer of claim 1, wherein an end of the tail is configured to connect to a solder ball.

7. The interposer of claim 1, wherein the first contact portion forms part of a land grid array (LGA) interface with the first component and the tail forms part of a ball grid array (BGA) interface with the second component.

8. The interposer of claim 1, wherein the curved beam further comprises:
a first bent portion forming at least part of the first contact portion;
a second bent portion forming at least part of the second contact portion; and
a straight portion directly coupling the first and second bent portions to one another.

9. The interposer of claim 8, wherein, when the curved beam is uncompressed, the straight portion defines an angle relative to the landing strip that is between 60° and 80°.

10. The interposer of claim 1, wherein when the second contact portion is in contact with the landing strip, the contact is configured to:
reduce maximum impedance variation by at least five ohms in signals transmitted between the first electrical component and the second electrical component,
reduce maximum insertion loss of signals transmitted between the first electrical component and the second electrical component by at least 20 dB in a frequency range of 0-50 GHz,
reduce maximum return loss of signals transmitted between the first electrical component and the second electrical component by at least 30 dB in a frequency range of 0-50 GHz, and/or
reduce losses from mode conversion in signals transmitted between the first electrical component and the second electrical component in a frequency range of 0-70 GHZ,
compared to when the second contact portion is not in contact with the landing strip.

11. The interposer of claim 1, wherein a spring rate of a straight portion between the first and second contact portions is configured to decrease in response to compression of the curved beam.

12. The interposer of claim 1, wherein a spring rate of a body portion between the first contact portion and the tail is configured to decrease in response to compression of the curved beam.

13. An interposer configured to place a first component in electrical communication with a second component, the interposer comprising:
a contact, disposed at least partially in a housing, comprising a curved beam, a tail and a landing strip, wherein the curved beam comprises:
a first contact portion; and
a second contact portion configured to contact the landing strip in response to compression of the curved beam by the first component at the first contact portion,
wherein the contact is shaped so that, in response to compression of the curved beam by the first component, the first contact portion and the second contact portion slide in opposite directions; and
wherein the housing is arranged to allow for clearance of movement for the curved beam in response to compression of the curved beam by the first component.

14. The interposer of claim 13, wherein the housing comprises a first surface and a second surface opposite the first surface, wherein the curved beam is near the first surface and the tail is near the second surface, wherein a majority of the curved beam is exposed outside of the housing.

15. The interposer of claim 14, wherein an entirety of the curved beam is exposed outside of the housing.

16. The interposer of claim 13, wherein an end of the tail is configured to connect to a solder ball.

17. The interposer of claim 13, wherein the first contact portion forms part of a land grid array (LGA) interface with the first component and the tail forms part of a ball grid array (BGA) interface with the second component.

18. The interposer of claim 13, wherein the first contact portion is configured to slide along the first component in a direction opposite that which the second contact portion slides along the landing strip.

19. An interposer configured to place a first component in electrical communication with a second component, the interposer comprising:
a housing; and
a contact, disposed at least partially in the housing, wherein the contact is arranged to:
generate a first spring rate in response to compression of the contact between the first component and the second component by a first amount; and
after being compressed by the first amount, generate a second spring rate in response to further compression of the contact between the first component and the second component by a second amount,
wherein the second spring rate is less than the first spring rate.

20. The interposer of claim 19, wherein the contact comprises a curved beam, a tail and a landing strip, wherein the curved beam comprises:
a first contact portion; and
a second contact portion configured to contact the landing strip in response to compression of the curved beam by the first component at the first contact portion,
wherein the tail is configured to provide a rigid connection to the second component.

21. The interposer of claim 20, wherein the curved beam is shaped so that, in response to compression of the contact by the first component, the first contact portion and the second contact portion slide in opposite directions.

22. The interposer of claim 20, wherein the housing comprises a first surface and a second surface opposite the first surface, wherein the curved beam is near the first surface and the rigid connection is near the second surface, wherein a majority of the curved beam is exposed outside of the housing.

23. The interposer of claim 20, wherein the housing is arranged to allow for clearance of movement for the curved beam in response to compression of the curved beam by the first component.

24. The interposer of claim 20, wherein a spring rate of a straight portion between the first and second contact portions is configured to decrease in response to compression of the curved beam.

25. The interposer of claim 20, wherein a spring rate of a body portion between the first contact portion and the tail is configured to decrease in response to compression of the curved beam.

26. The interposer of claim 19, wherein the first amount ranges up to 0.145 mm and the second amount ranges up to 0.255 mm.

27. The interposer of claim 19, wherein the first spring rate ranges from 69 g/mm to 77 g/mm and the second spring rate ranges from 40.7 g/mm to 43 g/mm.
